(19) United States
(12) Patent Application Publication
(10) Pub. No.: US 2010/0060345 A1
(43) Pub. Date: Mar. 11, 2010

(54) REFERENCE CIRCUIT FOR PROVIDING PRECISION VOLTAGE AND PRECISION CURRENT

(75) Inventors: Din-Jiun Huang, Hsinchu City (TW); Kuan-Yu Chen, Hsinchu City (TW); Yuan-Hsun Chang, Hsinchu City (TW)

Correspondence Address: WPAT, PC;INTELLECTUAL PROPERTY ATTORNEYS, 7225 BEVERLY ST., ANNANDALE, VA, 22003, US

(73) Assignee: FARADAY TECHNOLOGY CORPORATION, Hsinchu (TW)

(21) Appl. No.: 12/437,699

(22) Filed: May 8, 2009

(30) Foreign Application Priority Data
Sep. 8, 2008 (TW) 097134441

(51) Int. Cl. G05F 3/02

(52) U.S. Cl. 327/539

(57) ABSTRACT

A reference circuit for providing a precision voltage and a precision current includes a bandgap voltage reference circuit, a positive temperature coefficient calibrating circuit, a threshold voltage superposing circuit and precision current generator interconnected in cascade. From the bandgap voltage reference circuit, a bandgap voltage is outputted as the precision voltage, and a PTAT current is outputted to the positive temperature coefficient calibrating circuit along with the bandgap voltage for generating a PTAT voltage. In response to the PTAT voltage from the positive temperature coefficient calibrating circuit, the threshold voltage superposing circuit generates a first voltage which is equal to the PTAT voltage plus a threshold voltage. Then the precision current generator outputs a reference current as the precision current in response to the first voltage.

### FIELD OF THE INVENTION

The present invention relates to a reference circuit, and more particularly, to a reference circuit for providing both a precision voltage and a precision current.

### BACKGROUND OF THE INVENTION

In the design of high-speed I/O circuits such as USB interfaces or SATA interfaces, it is necessary to use a precision voltage and a precision current as references for impedance matching. Please refer to FIG. 1, which is a diagram illustrating a reference circuit capable of providing a precision voltage and a precision current according to prior art. As shown, an IC circuit 10 includes a bandgap voltage reference circuit 12, an operational amplifier 14, a mirroring circuit 16, a transistor M₁, and an I/O pad 18.

Generally speaking, the bandgap reference circuit 12 is used for providing a stable bandgap voltage (V_{BG}), which will not change as the manufacturing process, the temperature or the supply voltage changes. Therefore, the bandgap voltage V_{BG} outputted by the bandgap voltage reference circuit 12 can be viewed as a precision voltage. As shown in FIG. 1, the bandgap voltage V_{BG} is inputted to a positive input terminal of the operational amplifier 14, and a negative input terminal of the operational amplifier 14 is connected to the I/O pad 18 of the IC circuit 10. In addition, the drain of the transistor M₁ is connected to a first terminal of the mirroring circuit 16, the gate of the transistor M₁ is connected to the output terminal of the operational amplifier 14, and the source of the transistor M₁ is connected to the I/O pad 18 of the IC circuit 10. The IC circuit 10 further utilizes an external precision resistor R_{P} connected between the I/O pad 18 and ground.

Obviously, when the operational amplifier 14 operates normally, the voltage at the I/O pad 18 of the IC circuit 10 will be the bandgap voltage V_{BG} and thus a first current I₁ flowing through the external precision resistor R_{P} is (V_{BG}/R_{P}). In addition, this first current I₁ is outputted through the first terminal of the mirroring circuit 16, and the second terminal of the mirroring circuit 16 can also output a reference current I_{ref}, which is directly proportional to the first current I₁ and can be viewed as a precision current. In other words, the intensity of the precision current can be determined according to the resistance of the external precision resistor R_{P}.

According to the prior art, in order to obtain both the precision voltage and the precision current in the same circuitry, the I/O pad 18 is designed in the IC circuit 10 and connected to the external precision resistor R_{P} to generate the precision current. In other words, an external precision resistor is required and needs to be additionally disposed on the circuit board, which results in inefficient problems in space and cost.

In addition, due to the I/O pad 18 being designed in the IC circuit 10, the designer of the IC circuit 10 must design an electrostatic discharge protection circuit (ESD) to protect the I/O pad 18. Accordingly, the layout area of the IC circuit 10 is increased. If the I/O pad 18 is disposed in the IC circuit 10, another problem of generating noise on the I/O pad 18 might be caused.

Furthermore, the stability of the operational amplifier 14 is decided by its phase margin. If the operational amplifier 14 is unstable, the parasitic capacitance on the I/O pad 18 is hard to be estimated, which might result in loop instability and loop oscillation.

In order to obtain the precision voltage and the precision current, a reference voltage distribution system is disclosed in the International Patent Application No. PCT/US90/05473. This system generates a precision current according to an external reference voltage and a controllable resistance. However, this system needs an additional control circuit for controlling the resistance.

In addition, a dual source for constant current and PTAT (proportional to absolute temperature) current is disclosed in the International Patent Application No. PCT/US96/18048, wherein a bandgap voltage reference circuit is used to generate a bandgap reference voltage (V_{BG}) and a PTAT voltage (V_{PTAT}), and thereby generate the precision current and the PTAT current. Likewise, an external precision resistor is still needed in order to generate the precision current and the PTAT current.

Moreover, in the periodical “IEEE TRANSACTIONS ON CIRCUITS AND SYSTEMS”, vol. 50, no. 12, Dec. 2003, a new low voltage precision CMOS current reference circuit with no external components is proposed. Please refer to FIG. 2. FIG. 2 is a diagram illustrating a circuitry disposed in an IC circuit and capable of providing a precision current according to the prior art. The IC circuit 30 includes a bandgap voltage reference circuit 32 with a positive temperature coefficient, an operational amplifier 34, a mirroring circuit 36, and transistors M₁, M₂ and M₃.

The bandgap voltage reference circuit 32 with positive temperature coefficient is used for providing a temperature-dependent bandgap voltage (V_{BG}), which increases as the temperature rises. As shown in FIG. 2, the bandgap voltage V_{BG} is inputted to the positive input terminal of the operational amplifier 34, and the negative input terminal of the operational amplifier 34 is connected to the drain of the transistor M₁. In addition, the drain of the transistor M₃ is connected to a first terminal of the mirroring circuit 36, the gate of the transistor M₃ is connected to the output terminal of the operational amplifier 34, and the source of the transistor M₃ is connected to the drain of the transistor M₁. The source of the transistor M₁ is grounded, and the gate of the transistor M₁ is connected to the gate of the transistor M₂. The source of the transistor M₂ is grounded, and the gate and the drain of the transistor M₂ are connected to a second terminal of the mirroring circuit 36.

In the IC circuit 30, the transistor M₁ has to be operated in a triode region and the transistor M₂ has to be operated in a saturation region to make the transistor M₁ exhibit a feature of negative temperature coefficient. Hence, by collocating the bandgap voltage (V_{BG}) with the positive temperature coefficient and the transistor M₁ with the negative temperature coefficient, a precise first current I₁ can be generated. In addition, with the first current I₁ being outputted from the first terminal of the mirroring circuit 36, a reference current I_{ref} is outputted from the second terminal of the mirroring circuit 36 The reference current I_{ref} is directly proportional to the first current I₁ and can be viewed as a precision current.

Although providing a precision current, the abovementioned circuitry does not provide any precision voltage. Hence, an additional bandgap voltage reference circuit is required to provide a temperature-independent bandgap voltage (V_{BG}). In addition, due to possible deviations rendered by mass production in the manufacturing process of the IC circuit, it is difficult to control the transistor M₁ to be operated in the triode region.

### SUMMARY OF THE INVENTION

It is therefore one of the objectives of the present invention to provide a reference circuit disposed in an IC circuit for providing both a precision voltage and a precision current with transistors of the reference circuit all operating in saturation regions.

According to an exemplary embodiment of the present invention, a reference circuit for providing both a precision voltage and a precision current is provided. The reference circuit includes a bandgap voltage reference circuit outputting a bandgap voltage as the precision voltage at a first voltage output terminal and outputting a PTAT current at a current output terminal in response to a power supply; a positive temperature coefficient calibrating circuit connected to the first voltage output terminal and the current output terminal of the bandgap voltage reference circuit for generating a PTAT voltage at a second voltage output terminal in response to the bandgap voltage and the PTAT current; a threshold voltage superposing circuit connected to the second voltage output terminal of the positive temperature coefficient calibrating circuit for generating a first voltage at a third voltage output terminal in response to the PTAT voltage, wherein the first voltage is generated according to (or equals to) the PTAT voltage plus a threshold voltage; and a precision current generator connected to the third voltage output terminal of the threshold voltage superposing circuit for outputting a reference current as the precision current at a reference current output terminal in response to the first voltage.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a diagram illustrating a reference circuit capable of providing a precision voltage and a precision current according to prior art;

FIG. 2 is a diagram illustrating a circuit disposed in an IC circuit and capable of providing a precision current according to another prior art;

FIG. 3 is a diagram illustrating a reference circuit capable of providing both a precision voltage and a precision current according to an embodiment of the present invention;

FIG. 4 is a diagram showing an embodiment of a bandgap voltage reference circuit applicable to the reference circuit of FIG. 3;

FIG. 5 is a diagram showing an embodiment of a positive temperature coefficient calibrating circuit applicable to the reference circuit of FIG. 3;

FIG. 6 is a diagram showing an embodiment of a threshold voltage superposing circuit applicable to the reference circuit of FIG. 3; and

FIG. 7 is a diagram showing an embodiment of a precision current generator applicable to the reference circuit of FIG. 3.

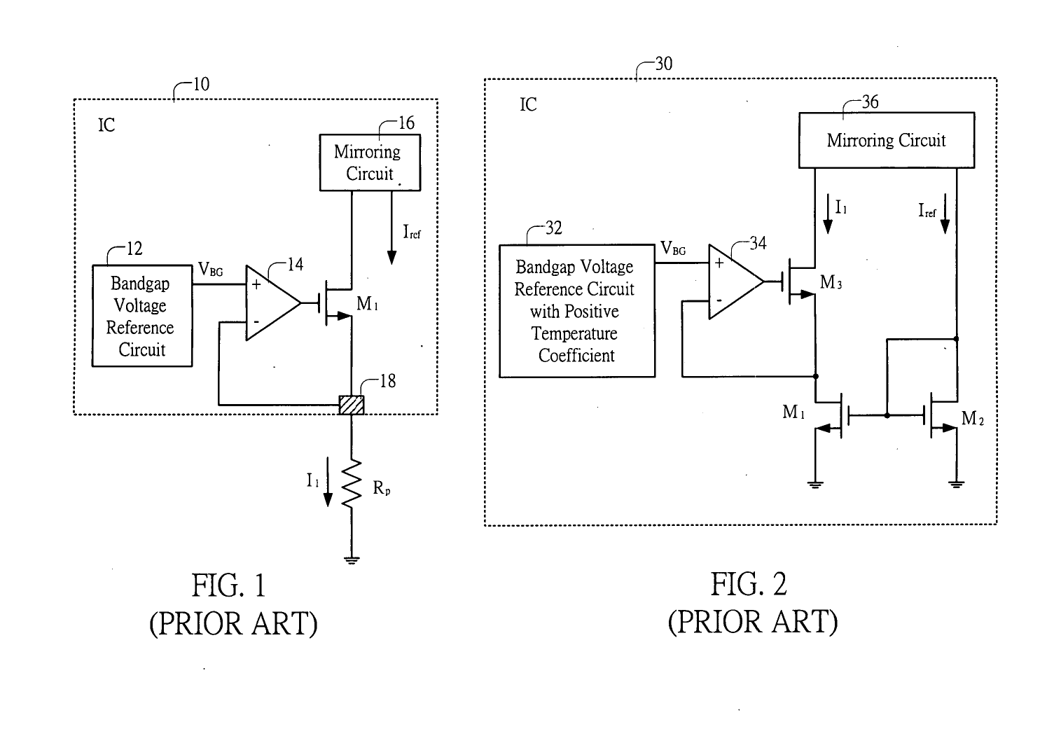

### DETAILED DESCRIPTION OF THE PREFERRED EMBODIMENT

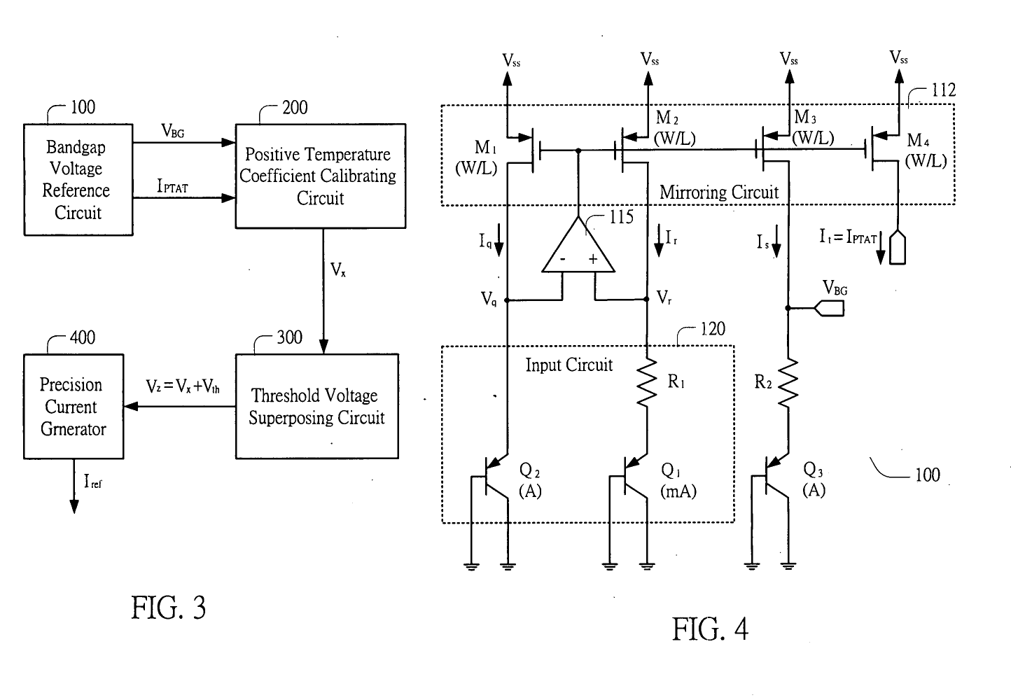

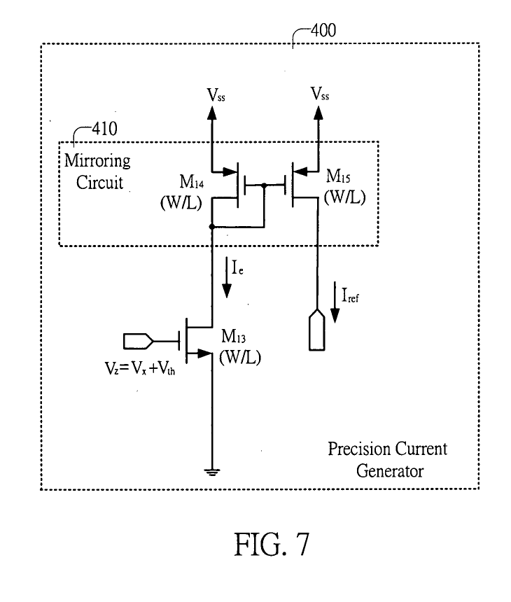

Please refer to FIG. 3, which is a diagram illustrating a reference circuit capable of providing both a precision voltage and a precision current according to an embodiment of the present invention. The reference circuitry includes a bandgap voltage reference circuit 100, a positive temperature coefficient calibrating circuit 200, a threshold voltage superposing circuit 300, and a precision current generator 400. The details of respective circuits are described hereinafter with reference to FIG. 4˜FIG. 7.

FIG. 4 illustrates an embodiment of the bandgap voltage reference circuit 100. The bandgap voltage reference circuit 100 includes PMOS field-effect transistors, PNP bipolar transistors and operational amplifiers constituting a first mirroring circuit 112, a first operational amplifier 115 and an input circuit 120. The mirroring circuit 112 includes four PMOS field-effect transistors (FET) M₁, M₂, M₃ and M₄. In this embodiment, the four PMOS FETs M₁, M₂, M₃ and M₄ have the same aspect ratio (W/L). The gates of the four PMOS FETs M₁, M₂, M₃ and M₄ are connected to each other, the sources of the four PMOS FETs M₁, M₂, M₃ and M₄ are coupled to a power supply (V_{SS}), and from the drains of the four PMOS FETs M₁, M₂, M₃ and M₄, output currents I_{q}, Iᵣ, Iₛ, and Iₜ are respectively outputted. Moreover, an output terminal of the first operational amplifier 115 is connected to the gates of the PMOS FETs M₁, M₂, M₃ and M₄, a positive input terminal of the first operational amplifier 115 is connected to the drain of the PMOS FET M₂, and a negative input terminal of the first operational amplifier 115 is connected to the drain of the PMOS FET M₁. On the other hand, the input circuit 120 includes two PNP bipolar transistors (BJT) Q₁ and Q₂. The bases and collectors of the BJTs Q₁ and Q₂ are grounded to make Q₁ and Q₂ diode-connected. The emitter of the BJT Q₂ is connected to the negative input terminal of the first operational amplifier 115, and a first resistor R₁ is connected between the emitter of the BJT Q₁ and the positive input terminal of the first operational amplifier 115.

In addition, the area of the PNP BJT Q₃ is the same as the area of the BJT Q₂. The base and the collector of the BJT Q₃ are grounded; a second resistor R₂ is connected between the emitter of the BJT Q₃ and the drain of M₃; and from the drain of M₃, a bandgap voltage (V_{BG}) is outputted.

Since the four PMOS FETs M₁, M₂, M₃ and M₄ have the same aspect ratio, the current I_{q} outputted from the drain of the PMOS FET M₁, the current Iᵣ outputted from the drain of the PMOS FET M₂, the current Iₛ outputted from the drain of the PMOS FET M₃, and the current Iₜ outputted from the drain of the PMOS FET M₄ are substantially equal when the PMOS FETs M₁, M₂, M₃ and M₄ operate in saturation regions, as expressed by the following equation:

I_{q}=Iᵣ=Iₛ=Iₜ (1).

If the first operational amplifier 115 has an infinite (or substantially large) gain, which means a voltage V_{q} at the negative input terminal of the operational amplifier 115 is equal to a voltage Vᵣ at the positive input terminal of the operational amplifier 115, so that the following equation is complied with:

R₁Iᵣ+V_{EB1}=V_{EB2} (2),

where V_{EB1} is an emitter-base voltage of the BJT Q₁; and V_{EB2} is an emitter-base voltage of the BJT Q₂.

As the BJTs Q₁ and Q₂ are diode-connected and on a condition that the area of the BJT Q₁ is m times the area of the BJT Q2, it is realized that

$${I}_{q} = {I}_{s 0} {e}^{\frac{{V}_{EB 2}}{{V}_{t}}} and {I}_{r} = {mI}_{s 0} {e}^{\frac{{V}_{EB 1}}{{V}_{t}}} ,$$

where I_{S0} is a saturation current of the BJT Q₂ and Vₜ represents a thermal voltage. Accordingly, the following equations are obtained:

V_{BE1}=Vₜ·1n(Iᵣ/mIₛ₀) (3), and

V_{BE2}=Vₜ·1n(I_{q}/Iₛ₀) (4).

By combining the equations (1), (2), (3) and (4), the following equations are obtained:

Iᵣ=(1/R₁)·Vₜ·1n(m) (5), and

V_{BG}=(R₂/R₁)·Vₜ·1n(m)+V_{EB3} (6),

where V_{EB3} is an emitter-base voltage of the BJT Q₃.

As can be realized from the equation (6), the bandgap voltage V_{BG} is equal to the emitter-base voltage V_{EB3} of the BJT Q₃ plus a product of the thermal voltage (Vₜ) multiplying a temperature-independent scalar C₁, wherein C₁=(R₂/R₁)·1n(m). As the emitter-base voltage V_{BE3} exhibits a feature of negative temperature coefficient and the thermal voltage Vₜ exhibits a feature of positive temperature coefficient, the bandgap voltage V_{BG} with a zero temperature coefficient can be obtained as a result of the addition of the thermal voltage (Vₜ) with a weighing factor, i.e. the constant C₁, and the emitter-base voltage V_{BE3}. In other words, the bandgap voltage V_{BG} is substantially a constant at whichever temperature. In other words, the bandgap voltage V_{BG} will not change with temperature.

On the other hand, according to the equation (5), Iᵣ is equal to a product of the thermal voltage Vₜ multiplying a temperature-independent scalar C₂, wherein C₂=(1/R₁)·1n(m). Since the thermal voltage Vₜ exhibits a feature of positive temperature coefficient, Iᵣ will increase as the temperature rises. Hence, Iᵣ is also called as a proportional to absolute temperature (PTAT) current (I_{PTAT}). Further according to the equation (1), i.e. I_{q}=Iᵣ=Iₛ=Iₜ, the output Iₜ from the current output terminal of the bandgap voltage reference circuit 100 is equal to the PTAT current I_{PTAT}. Then the output current I_{PTAT}, along with the bandgap voltage V_{BG} outputted from a first voltage output terminal of the bandgap voltage reference circuit 100, is provided to next stage of the reference circuitry, i.e. the positive temperature coefficient calibrating circuit 200.

It is understood to those skilled in the art that the bandgap voltage reference circuit 100 is just an embodiment of circuit applicable to the reference circuitry of the present invention. Other suitable electronic components can be used in other embodiments of the bandgap voltage reference circuit to provide bandgap voltage V_{BG} and PTAT current I_{PTAT} for downstream circuits. For example, another embodiment of the bandgap voltage reference circuit can be implemented with all MOS transistors.

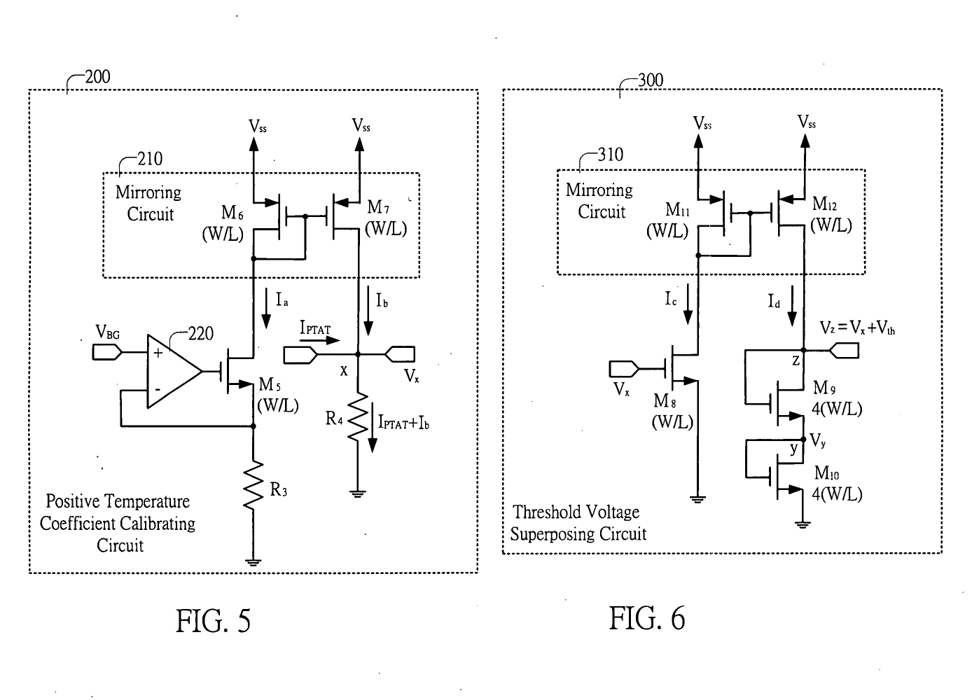

Please refer to FIG. 5. FIG. 5 is a diagram showing an embodiment of the positive temperature coefficient calibrating circuit 200. The positive temperature coefficient calibrating circuit 200 includes a second mirroring circuit 210, a second operational amplifier 220, an NMOS FET M₅, a third resistor R₃, and a fourth resistor R₄. The second mirroring circuit 210 includes two PMOS FETs M₆ and M₇. In this embodiment, the PMOS FETs M₆ and M₇ have the same aspect ratio (W/L). The gates of the PMOS FETs M₆ and M₇ are connected to each other, the sources of the PMOS FETs M₆ and M₇ are connected to the power supply V_{SS}; the drain of the PMOS FET M₆ is connected to the gate of the PMOS FET M₆ and can be viewed as a first terminal of the second mirroring circuit 210; and the drain of the PMOS FET M₇ can be viewed as a second terminal of the second mirroring circuit 210. When the PMOS FETs M₆ and M₇ operate in saturation regions, the intensities of the currents outputted from the first terminal and the second terminal of the second mirroring circuit 210 are equal, i.e. Iₐ=I_{b}.

A positive input terminal of the second operational amplifier 220 is connected to the first voltage output terminal of the bandgap voltage reference circuit 100 for receiving the bandgap voltage V_{BG}, and the negative input terminal of the second operational amplifier 220 is connected to the source of the NMOS FET M₅. The drain of the NMOS FET M₅ is connected to the first terminal of the second mirroring circuit 210; the gate of the NMOS FET M₅ is connected to the output terminal of the second operational amplifier 220; and the third resistor R₃ is coupled between the source of the NMOS FET M₅ and ground. The second terminal of the second mirroring circuit 210 can be viewed as the second voltage output terminal x of the positive temperature coefficient calibrating circuit 200, which is connected to the current output terminal of the bandgap voltage reference circuit 100 and coupled to ground through the fourth resistor R₄.

Obviously, when the second operational amplifier 220 operates normally, the voltage at the negative input terminal of the second operational amplifier 220 is equal to the bandgap voltage V_{BG}. Hence, Iₐ equals to V_{BG}/R₃. In addition, the current Iₐ outputted from the first terminal of the second mirroring circuit 220 and the current I_{b} outputted from the second terminal of the second mirroring circuit 220 are equal. Furthermore, since the second voltage output terminal x is connected to the current output terminal of the bandgap voltage reference circuit 100, the current flowing through the fourth resistor R₄ is (I_{PTAT}+I_{b}), and the voltage at the second voltage output terminal is:

Vₓ=V_{BG}(R₄/R₃)+I_{PTAT}·R₄ (7),

where Vₓ is a voltage at the second voltage output terminal x.

According to the equation (7), and as is known that I_{PTAT} increases as the temperature rises, the voltage Vₓ at the second voltage terminal x is equal to a sum of a temperature-independent voltage C₃, where C₃=V_{BG}(R₄/R₃), and a voltage with positive temperature coefficient, i.e. I_{PTAT}·R₄. Hence, the voltage Vₓ at the second voltage output terminal x can be viewed as a PTAT voltage to be provided for next stage of the reference circuitry, i.e. the threshold voltage superposing circuit 300. It is understood that the circuit designer may use the resistance of the third resistor R₃ to provide an offset voltage to change C₃ and calibrate the voltage Vₓ.

Please refer to FIG. 6. FIG. 6 is a diagram showing an embodiment of the threshold voltage superposing circuit 300. The threshold voltage superposing circuit 300 includes a third mirroring circuit 310, and three NMOS FETs M₈, M₉ and M₁₀. The NMOS FETs M₈, M₉ and M₁₀ have the same threshold voltage Vₜₕ; the NMOS FETs M₉ and M₁₀ have the same aspect ratio (W/L); and the aspect ratio of the NMOS FET M₉ is four times the aspect ratio of the NMOS FET M₈. The third mirroring circuit 310 includes two PMOS FETs M₁₁, and M₁₂. In this embodiment, the PMOS FET M₁₁, and M₁₂ have the same aspect ratio (W/L). The gates of the PMOS FETs M₁₁ and M₁₂ are connected to each other; the sources of the PMOS FETs M₁₁ and M₁₂ are connected to a power supply V_{SS}; the drain of the PMOS FET M₁₁ is connected to the gate of the PMOS FET M₁₁ and can be viewed as a first terminal of the third mirroring circuit 310; and the drain of the PMOS FET M₁₂ can be viewed as a second terminal of the third mirroring circuit 310. When the PMOS FETs M₁₁ and M₁₂ operate in saturation regions, the intensities of the currents outputted from the first terminal and the second terminal of the third mirroring circuit 310 are equal, i.e. I_{c}=I_{d}.

Moreover, the second voltage output terminal x of the positive temperature coefficient calibrating circuit 200 is connected to the gate of the NMOS FET M₈; the source of the NMOS FET M₈ is grounded; and the drain of the NMOS FET M₈ is connected to the first terminal of the third mirroring circuit 310. In addition, the second terminal of the third mirroring circuit 310 can be viewed as a third voltage output terminal z of the threshold voltage superposing circuit 300, and the diode-connected NMOS FETs M₉ and M₁₀ are cascaded between the third voltage output terminal z and ground.

When the NMOS FETs M₈, M₉ and M₁₀ in the threshold voltage superposing circuit 300 operate in saturation regions, the current I_{c} is equal to K(Vₓ−Vₜₕ)², where K is a device transconductance parameter or a manufacture parameter and has a feature of negative temperature coefficient. Due to the aspect ratio of the NMOS FET M₁₀ being four times the aspect ratio of the NMOS FET M₈ and I_{c}=I_{d}, the current I_{d} is equal to 4K(V_{y}−Vₜₕ)² where V_{y} is a voltage at a node “y” among the source of the NMOS FET M₉ and the gate and drain of the NMOS FET M₁₀ and V_{y}=(Vₓ+Vₜₕ)/2. The voltage V_{z} at the third voltage output terminal z is equal to 2V_{y}=2(Vₓ+Vₜₕ)/2=Vₓ+Vₜₕ. That is to say, the voltage V_{z} at the third voltage output terminal z is equal to the voltage Vₓ at the second voltage output terminal x of the positive temperature coefficient calibrating circuit 200 plus the threshold voltage Vₜₕ. The voltage V_{z} is further provided to next stage of the reference circuitry, i.e. precision current generator 400.

Please refer to FIG. 7. FIG. 7 is a diagram showing an embodiment of the precision current generator 400. The precision current generator 400 includes a fourth mirroring circuit 410 and an NMOS FET M₁₃, wherein the NMOS FET M₁₃ has the same aspect ratio as the NMOS FET M₈ in the threshold voltage superposing circuit 300. The fourth mirroring circuit 410 includes two PMOS FETs M₁₄ and M₁₅. In this embodiment, the PMOS FETs M₁₄ and M₁₅ have the same aspect ratio; the gates of the PMOS FETs M₁₄ and M₁₅ are connected to each other; the sources of the PMOS FETs M₁₄ and M₁₅ are connected to the power supply V_{SS}; the drain of the PMOS FET M₁₄ is connected to the gate of the PMOS FET M₁₄ and can be viewed as a first terminal of the fourth mirroring circuit 410; and the drain of the PMOS FET M₁₅ can be viewed as a second terminal of the fourth mirroring circuit 410. When the PMOS FETs M₁₄ and M₁₅ operate in saturation regions, the intensities of the currents outputted from the first terminal and the second terminal of the fourth mirroring circuit 410 are equal, i.e. Iₑ=I_{ref}.

In this embodiment, the third voltage output terminal z of the threshold voltage superposing circuit 300 is connected to the gate of the NMOS FET M₁₃; the source of the NMOS FET M₁₃ is grounded; and the drain of the NMOS FET M₁₃ is connected to the first terminal of the fourth mirroring circuit 410.

When the NMOS FET M₁₃ in the precision current generator 400 operates in a saturation region, the current I_{ref} and the current Iₑ are the same and can be presented by the equation I_{ref}=Iₑ=K(V_{z}−Vₜₕ)²=K(Vₓ+Vₜₕ−Vₜₕ)²=K·Vₓ². Since K exhibits the feature of negative temperature coefficient, as mentioned above, and the voltage Vₓ exhibits the feature of positive temperature coefficient, a temperature-independent current I_{ref} can be outputted from the second terminal of the fourth mirroring circuit 410 by appropriately adjusting the values of K and Vₓ. The resulting temperature-independent current I_{ref} can thus be obtained as a precision current.

It is understood from the above descriptions that both a precision voltage and a precision current can be obtained by the reference circuit according to the present invention, which is disposed in an IC circuit without the need of any external resistor. Furthermore, by operating all the transistors of the reference circuit in saturation regions, deviations possibly occurring during the manufacturing process of the IC circuit can be remedied.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A reference circuit for providing both a precision voltage and a precision current, comprising:
a bandgap voltage reference circuit outputting a bandgap voltage as the precision voltage at a first voltage output terminal and outputting a proportional to absolute temperature (PTAT) current at a current output terminal in response to a power supply;
a positive temperature coefficient calibrating circuit connected to the first voltage output terminal and the current output terminal of the bandgap voltage reference circuit for generating a PTAT voltage at a second voltage output terminal in response to the bandgap voltage and the PTAT current;
a threshold voltage superposing circuit connected to the second voltage output terminal of the positive temperature coefficient calibrating circuit for generating a first voltage at a third voltage output terminal in response to the PTAT voltage, wherein the first voltage is generated according to the PTAT voltage plus a threshold voltage; and
a precision current generator connected to the third voltage output terminal of the threshold voltage superposing circuit for outputting a reference current as the precision current at a reference current output terminal in response to the first voltage.

2. The reference circuit of claim 1, wherein the PTAT voltage is generated according to a temperature-independent voltage plus a voltage with a positive temperature coefficient.

3. The reference circuit of claim 1, wherein the bandgap voltage reference circuit comprises:
a first mirroring circuit having a first terminal, a second terminal, a third terminal for outputting the bandgap voltage and a fourth terminal which serves as the current output terminal for outputting the PTAT current;
a first operational amplifier having a positive input terminal connected to the second terminal of the first mirroring circuit and a negative input terminal connected to the first terminal of the first mirroring circuit;
a first resistor;
a second resistor;
a first BJT transistor, wherein the first resistor is connected between an emitter of the first BJT transistor and the second terminal of the first mirroring circuit;
a second BJT transistor having an emitter connected to the first terminal of the first mirroring circuit and a base and a collector grounded; and
a third BJT transistor, wherein the second resistor is connected between an emitter of the third BJT transistor and the third terminal of the first mirroring circuit, and a base and a collector of the third BJT transistor are grounded;
wherein an area of the first BJT transistor is m times an area of the second BJT transistor.

4. The reference circuit of claim 3, wherein the first mirroring circuit comprises:
a first MOS field-effect transistor, a second MOS field-effect transistor, a third MOS field-effect transistor and a fourth MOS field-effect transistor;
wherein gates of the four MOS field-effect transistors are connected to each other, sources of the four MOS field-effect transistors are connected to a power supply, and drains of the four MOS field-effect transistors respectively serve as the first terminal, the second terminal, the third terminal and the fourth terminal of the first mirroring circuit.

5. The reference circuit of claim 1, wherein the positive temperature coefficient calibrating circuit comprises:
a second mirroring circuit having a first terminal and a second terminal which serves as the second voltage output terminal and is connected to the current output terminal for receiving the PTAT current;
a second operational amplifier having a positive input terminal connected to the first voltage output terminal of the bandgap voltage reference circuit;
a fifth NMOS field-effect transistor having a source connected to a negative input terminal of the second operational amplifier, a drain connected to the first terminal of the second mirroring circuit, and a gate connected to an output terminal of the second operational amplifier;
a third resistor connected between the source of the fifth NMOS field-effect transistor and ground; and
a fourth resistor connected between the second terminal of the second mirroring circuit and ground.

6. The reference circuit of claim 5, wherein the second mirroring circuit comprises:
a sixth MOS field-effect transistor and a seventh MOS field-effect transistor;
wherein gates of the two MOS field-effect transistors are connected to each other, sources of the two MOS field-effect transistors are connected to a power supply, and drains of the two MOS field-effect transistors respectively serve as the first terminal and the second terminal of the second mirroring circuit.

7. The reference circuit of claim 1, wherein the threshold voltage superposing circuit comprises:
a third mirroring circuit having a first terminal and a second terminal which serves as the third voltage output terminal;
an eighth NMOS field-effect transistor having a gate connected to the second voltage output terminal, a drain connected to the first terminal, and a source grounded;
a ninth NMOS field-effect transistor having a gate and a drain connected to the second terminal of the third mirroring circuit; and
a tenth NMOS field-effect transistor having a gate and a drain connected to a source of the ninth NMOS field-effect transistor, and a source grounded.

8. The reference circuit of claim 7, wherein the third mirroring circuit comprises;
an eleventh MOS field-effect transistor and a twelfth MOS field-effect transistor;
wherein gates of the two MOS field-effect transistors are connected to each other, sources of the two MOS field-effect transistors are connected to a power supply, and drains of the two MOS field-effect transistors respectively serve as the first terminal and the second terminal of the third mirroring circuit.

9. The reference circuit of claim 7, wherein an aspect ratio of the eighth NMOS field-effect transistor is W/L, an aspect ratio of the ninth NMOS field-effect transistor is 4(W/L), and an aspect ratio of the tenth NMOS field-effect transistor is 4(W/L).

10. The reference circuit of claim 7, wherein the eighth NMOS field-effect transistor, the ninth NMOS field-effect transistor and the tenth NMOS field-effect transistor have substantially equal threshold voltages.

11. The reference circuit of claim 1, wherein the precision current generator comprises:
a fourth mirroring circuit having a first terminal and a second terminal which serves as the reference current output terminal; and
a thirteenth NMOS field-effect transistor having a gate connected to the third voltage output terminal of the threshold voltage superposing circuit, a drain connected to the first terminal of the fourth mirroring circuit, and a source grounded.

12. The reference circuit of claim 11, wherein the fourth mirroring circuit comprises:
a fourteenth MOS field-effect transistor and a fifteenth MOS field-effect transistor;
wherein gates of the two MOS field-effect transistors are connected to each other, sources of the two MOS field-effect transistors are connected to a power supply, and drains of the two MOS field-effect transistors respectively serve as the first terminal and the second terminal of the fourth mirroring circuit.
